(19) United States
(12) Patent Application Publication
(10) Pub. No.: US 2021/0056335 A1
(43) Pub. Date: Feb. 25, 2021

(54) VARIABLE IR ILLUMINATION

(71) Applicant: GENTEX CORPORATION, Zeeland, MI (US)

(72) Inventors: Benjamin N. Pohlman, Holland, MI (US); Joshua D. Lintz, Allendale, MI (US)

(73) Assignee: GENTEX CORPORATION, Zeeland, MI (US)

(21) Appl. No.: 16/999,607

(22) Filed: Aug. 21, 2020

Related U.S. Application Data
(60) Provisional application No. 62/890,628, filed on Aug. 23, 2019.

(51) Int. Cl. G06K 9/20; G06K 9/00; H04N 5/225

(52) U.S. Cl. CPC G06K 9/2027; G06K 9/00845; G06K 9/00268; G06K 9/00288; H04N 5/2256

(57) ABSTRACT

A variable infra-red illumination system and corresponding method is disclosed. The system may comprise a distance detector, a controller, an infra-red illumination device, and an imager. The distance detector may be operable to detect a first distance. The first distance may be a distance from a subject to the distance detector. The controller may be operable to determine an illumination intensity based, at least in part, on the first distance. The determined illumination intensity may be equal to or less than a maximum safe infra-red illumination intensity. The infra-red illumination device may be operable to illuminate a subject with infra-red light at the determined illumination intensity. Further, the infra-red illumination device may be located at a second distance from the subject. The second distance may be approximately equal to the first distance. The imager may be operable to capture one or more infra-red images of the illuminated subject.

### CROSS-REFERENCE TO RELATED APPLICATIONS

This application claims priority under 35 U.S.C. § 119(e) to U.S. provisional Application No. 62/890,628 filed on Aug. 23, 2019, entitled “VARIABLE IR ILLUMINATION,” the disclosure of which is hereby incorporated by reference in its entirety.

### FIELD OF INVENTION

The present invention relates in general to imaging devices and, more particularly, to infra-red illumination for imaging.

### BACKGROUND OF INVENTION

Devices that image in the infra-red spectrum have been well known for many years. Illuminating a subject in the infra-red spectrum during imaging increases the image quality of the subject. Further, illumination and imaging in the infra-red spectrum has the advantage of being outside of the visible spectrum of the human eye. Accordingly, when the subject is illuminated, the subject does not see the projected infra-red light.

Nonetheless, infra-red light is harmful to human skin and eyes. Accordingly, the infra-red light exposure to human subjects should be limited. Thus, some imaging systems have adopted a fixed infra-red illumination intensity, which is calibrated to be safe at any distance and/or exposure duration. Adopting any other fixed illumination intensity may risk harm to the subject. However, such a fixed intensity reduces the effectiveness of the illumination and thus the quality of the image. Accordingly, there is a need for an improved system for imaging and illuminating a subject in the infra-red spectrum.

### SUMMARY

In accordance with the present disclosure, the disadvantages and problems associated with imaging and illuminating subjects in the infra-red spectrum have been substantially reduced or eliminated.

In accordance with one aspect of the present disclosure, a variable infra-red illumination system is disclosed. The system may comprise a distance detector, a controller, an infra-red illumination device, and an imager. The distance detector may be operable to detect a first distance. The first distance is a distance from a subject to the distance detector. In some embodiments, the distance detector may comprise an emitter operable to emit an emission and an emission sensor. The emission sensor may be isolated from the emitter such that the sensor may not substantially detect the emission except when the emission is reflected off an object disposed in an anticipated subject occupation area. The emitter and sensor may be isolated or separated by a partition. The controller may be operable to determine an illumination intensity based, at least in part, on the first distance. The determined illumination intensity may be equal to or less than a maximum safe infra-red illumination intensity. In some embodiments, the determined infra-red illumination intensity may be zero when the first distance is below a threshold. The infra-red illumination device may be operable to illuminate a subject with infra-red light at the determined illumination intensity. The subject may be a vehicle driver or passenger. Further, the infra-red illumination device may be located at a second distance from the subject. The second distance may be approximately equal to the first distance. The imager may be operable to capture one or more infra-red images of the illuminated subject.

In some embodiments, the controller may additionally be operable to determine the subject's attentiveness based, at least in part, on the one or more images. The controller may additionally be operable to determine the subject's attentiveness further based, at least in part, on the first distance. In other embodiments, the controller may similarly be operable to extract at least one biometric signature of the subject from the one or more images. Further, the controller may be operable to match the biometric signature to a subject profile. The subject profile may comprise one or more subject preferences. A subject preference may be one of seat position, window tint, radio station, radio volume, maximum vehicle speed, driving mode, dash illumination, mirror position, mirror vs display selection, steering wheel position, pedal position, or lighting preference. The controller may then implement the one or more subject preferences. In some further embodiments, the controller may be further operable to determine the subject's location and limit the implementation of the one or more subject preferences based, at least in part, on the subject's location, such that one or more of the subject preferences is not implemented. Additionally or alternatively to implementing the preferences, the controller may be further operable to unlock a vehicle door based, at least in part, on the biometric signature.

In some embodiments, the system may be fully or partially incorporated into a rear-view assembly. The rear-view assembly may have a front surface, a rear-view portion, and an imaging window portion. The rear-view portion may be operable to provide a subject with a view in a rearward direction of a vehicle. The imaging window portion may be substantially transparent in the infra-red region of the electromagnetic spectrum. Further, the distance detector, the infra-red illumination device, and/or the imager may be disposed behind the front surface and/or optically aligned with the imaging window. The imaging window portion may be substantially opaque in the visible region of the electromagnetic spectrum.

In accordance with another aspect of the present disclosure, a method is disclosed. The method comprises detecting a subject's distance to an infra-red illumination device. Further, the method comprises determining an infra-red illumination intensity based, at least in part, on the detected distance. The determined infra-red illumination intensity may be equal to or less than a maximum safe infra-red illumination intensity. Additionally, the method comprises illuminating the subject with infra-red light by an infra-red illumination device at the determined infra-red illumination intensity. Moreover, the method comprises imaging the subject in the infra-red region with an imager to capture one or more images.

In some embodiments, the method may further comprise the step of determining the subject's attentiveness based, at least in part, on the one or more images. The subject's attentiveness may also be determined also based, at least in part, on the detected distance. Additionally or alternatively, the method may further comprise extracting at least one biometric signature from the one or more images. The biometric signature may accordingly be matched to a subject profile. The subject profile may comprise one or more preferences, which may in turn be implemented onto one or more pieces of equipment. In some further embodiments, subject's location may be determined, and the preferences implemented may be limited based, at least in part, on the subject's location such that one or more preference is not implemented. In other embodiments, a vehicle door may be unlocked based, at least in part, on the biometric signature.

The advantages of certain aspects of the present disclosure include heightened and/or maximum illumination of a subject based on the subject's distance, and therefore enables better imaging, while minimizing or substantially reducing the risks associated with infra-red exposure. Additionally, in aspects where the distance detector, the infra-red illumination device, and/or the imager are disposed behind and in optical communication with the imaging window, the system and/or method may have the further advantage of concealing one or more elements and providing a clean, sleek aesthetic appearance.

These and other aspects, objects, and features of the present disclosure will be understood and appreciated by those skilled in the art upon studying the following specification, claims, and appended drawings. It will also be understood that features of each embodiment disclosed herein may be used in conjunction with, or as a replacement for, features in other embodiments.

### BRIEF DESCRIPTION OF FIGURES

In the drawings:

FIG. 1: Schematic of an imaging system with variable IR illumination.

FIG. 2a: Forward perspective schematic of a rear-view assembly having an imaging system with variable IR illumination.

FIG. 2b: Cross sectional perspective schematic of an embodiment of a rear-view assembly.

FIG. 2c: Cross sectional perspective schematic of an embodiment of a rear-view assembly.

FIG. 2d: Cross sectional perspective schematic of an embodiment of a rear-view assembly.

FIG. 3: A process flow chart for variable IR illumination and imaging.

### DETAILED DESCRIPTION

For the purposes of description herein, the specific devices and processes illustrated in the attached drawings and described in this disclosure are simply exemplary embodiments of the inventive concepts defined in the appended claims. Hence, specific dimensions and other physical characteristics relating the embodiments disclosed herein are not to be considered limiting, unless the claims expressly state otherwise.

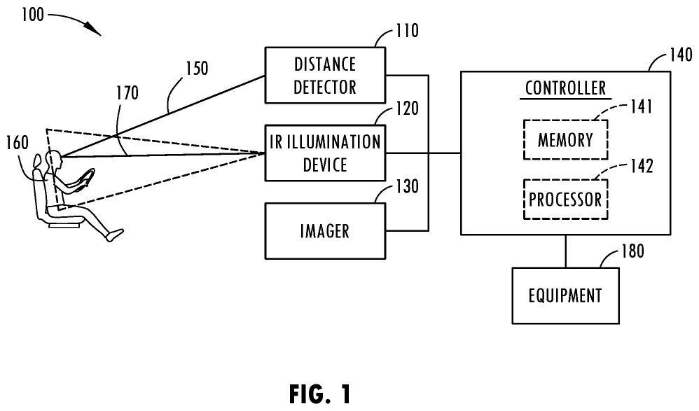

FIG. 1 illustrates a schematic drawing of a variable infra-red (“IR”) illumination imaging system 100. A variable IR illumination imaging system 100 may generally comprise: a distance detector 110, an IR illumination device 120, an imager 130, and a controller 140.

Distance detector 110 may be any device operable to detect a first distance 150 between itself and a subject 160. For example, distance detector 110 may be a radar detector, photoelectric sensor, lidar detector, or an ultrasonic sensor. Subject 160 may be an occupant of a vehicle. The occupant may be a driver or a passenger. The first distance 150 in some situations may be a distance between distance detector 110 and the subject's 160 head. In some embodiments, distance detector 110 may comprise an emitter and a sensor. For example, the emitter may be a device, such as a diode, operable to produce an emission, such as light, and the sensor may be a device, such as a light sensor, operable to detect the emission. The detection of the emission may be used to determine a distance to the subject. In some further embodiments, the emitter may be isolated from the sensor such that distance detector 110 does not determine false or erroneous distances. The isolation may be such that the emission by the emitter may not be substantially detected by the sensor except when the emission is reflected off an object disposed in an anticipated subject 160 occupation area. This isolation may be particularly beneficial when distance detector 100 is disposed behind a reflective surface in order to prevent the emission from being prematurely reflected from the emitter to the sensor.

IR illumination device 120 may be any device operable to emit light in the IR region of the electromagnetic spectrum. For example, IR illumination device 120 may be a light emitting diode (“LED”), halogen, quartz, incandescent, or compact fluorescent (“CFL”) light bulb. In some embodiments, IR illumination device 120 emits light substantially limited to the non-visible region of the electromagnetic spectrum. IR illumination device 120 may be disposed such that a second distance 170 between IR illumination device 120 and subject 160 is approximately equal to the first distance 150 between subject 160 and distance detector 110.

Imager 130 may be any device operable to capture light in the IR region and produce a digital image. Further, imager 130 may also capture the light substantially synchronously with an illumination by IR illumination device 120. Imager 130 may be a camera. For example, imager 130 may be a Semi-Conductor Charge-Coupled Device (CCD) or pixel sensor of Complementary Metal-Oxide-Semi-Conductor (CMOS) technologies. Additionally, imager 130 may be disposed such that IR light reflected off subject 160 is substantially directed to imager 130.

Controller 140 is operably connected to distance detector 110 and IR illumination device 120. Further, controller 140 may be any device operable to determine an IR illumination intensity based, at least in part, on the first distance 150 between distance detector 110 and subject 160. Accordingly, as first distance 150 may be approximately equal to second distance 170, the determined IR illumination intensity may be based, at least in part, on second distance 170. The IR illumination intensity may be determined by controller 140 by inputting first distance 150 into a graph, chart, look up table, and/or formula for IR illumination intensity as a function of distance, to make the determination. In some embodiments, the determined IR illumination intensity may be set for a range of first distances 150. In other words, the IR illumination may be determined according to a stepwise function. In some further embodiments, the determined IR illumination may be zero for a first distance 150 below a threshold. In other embodiments, the determined IR illumination intensity may be determined based on a continuous non-stepwise function at first distances 150. The determined IR illumination intensity may correspond to an intensity at or below a maximum safe IR illumination intensity for the respective distance or range of distances. IR illumination device 120 may accordingly illuminate subject 160 at the determined IR illumination intensity. In some embodiments, controller 140 may additionally be connected to imager 130 and/or may comprise a memory 141 and a processor 142.

Memory 141 may be operable to store the graph, chart, look up table, and/or formula for IR illumination intensity as a function of distance. Additionally, memory 141 may store one or more algorithm. In some embodiments, an algorithm may be operable to input the first distance 150 into the graph, chart, look up table, and/or formula to determine the IR illumination intensity. In other embodiments, an algorithm may be a subject analysis algorithm. The subject analysis algorithm may be operable to determine the subject's 160 attentiveness and/or extract at least one biometric signature based, at least in part, on one or more images captured by imager 130. In some further embodiments, the subject analysis algorithm may also base, at least in part, its attentiveness determination on the detected first distance 150. This may be particularly beneficial in embodiments where the first distance 150 between distance detector 110 and subject 160 corresponds to a distance between distance detector 110 and the subject's 160 head. Processor 142 may be operable to execute the subject analysis algorithm. The biometric signature, for example, may comprise one or more facial feature for facial recognition or iris structure for iris scanning.

In some further embodiments, memory 141 may be operable to store one or more subject profile. The subject profile may comprise one or more subject preference for one or more pieces of equipment 180. Equipment 180 may be, for example, a vehicle, a vehicle computer, a mirror, a window, a radio, a dashboard, a steering wheel, a foot pedal system, or a lighting system. The preference may be, for example, a seat position, window tint level, radio station, radio volume, maximum vehicle speed, driving mode, dashboard illumination, mirror position, rearview display vs mirror preference, steering wheel position, pedal position, and/or lighting level or color.

Additionally, in some embodiments, controller 140 may be operable to reconfigure one or more pieces of equipment 180 to implement a subject preference from the subject profile. In some further embodiments, controller 140 may be further operable to determine the subject's 160 location. The location may correspond to a seat within a vehicle. Such a determination may, for example, be based, at least in part, on analyzing one or more image, on receiving an articulation of imager 130, and/or on an imager 130 of origin for the image. Upon determining the subject location, controller 140 may limit the subject preferences implemented based, at least in part, on the subject's location, such that one or more subject preference is not implemented. For example, a subject 160 located in a passenger seat may have the preferences limited such that one or more of window tint level, radio station, radio volume, maximum vehicle speed, driving mode, dashboard illumination, mirror position, rearview display vs mirror selection, steering wheel position, pedal position, or lighting level or color preference of the subject profile are not implemented.

The subject profile may be created and/or modified in a number of ways. One such method is to have subject 160 manually input their preferences. Another method is to have memory 141 store equipment 180 configurations and, in some embodiments, the conditions surrounding the configurations, when in use by subject 160, over time. Accordingly, controller 140 may use an artificially intelligent or pattern recognition algorithm to analyze the stored data and synthesize a subject profile. In some further embodiments, controller 140 may use an artificially intelligent or pattern recognition algorithm to adapt or modify the subject profile.

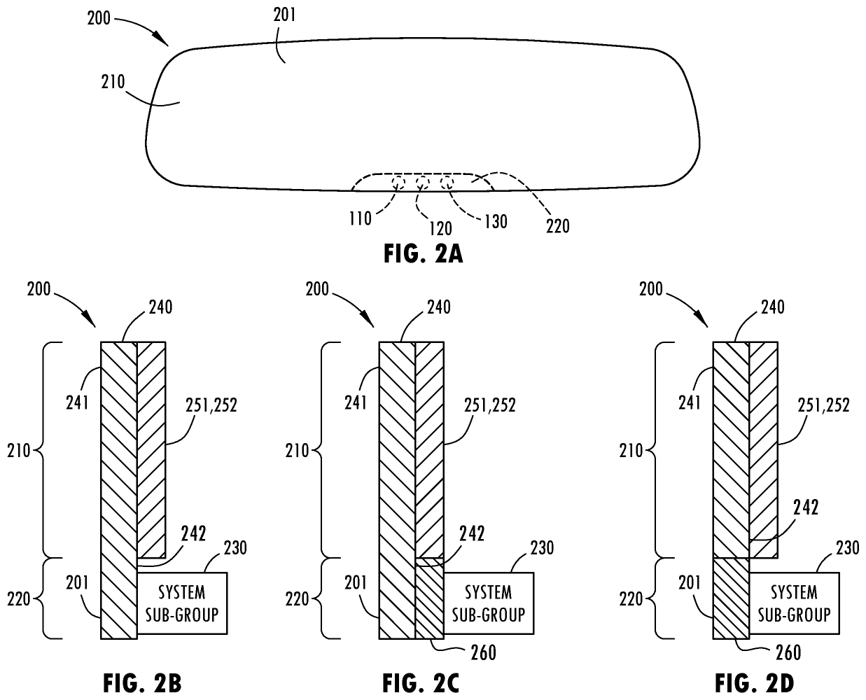

In some embodiments, as shown in FIGS. 2a-2d, variable IR illumination imaging system 100 may be incorporated, in part or in whole, into a rear-view assembly 200. Rear-view assembly 200 may be any device capable of providing subject 160 with a view in the rear-ward direction of a vehicle. In some embodiments, rear-view assembly 200 may be an interior rear-view assembly or an exterior side rear-view assembly. Accordingly, rear-view assembly 200 may comprise a rear-view portion. Further, distance detector 110, IR illumination device 120, and/or imager 130 may be disposed on, in, or adjacent to rearview assembly 200. In some further embodiments, distance detector 110, IR illumination device 120, and/or imager 130 may be incorporated, in part or in whole, into rear-view assembly 200 via an imaging window 220. Imaging window 220 may be placed in any location of rear-view assembly 200, such as, in one of the corners or on the bottom center of a front surface 201 of the rearview assembly 200. Front surface 201 may be a surface facing subject 160. Distance detector 110, IR illumination device 120, and/or imager 130 may be disposed behind and in optical communication with imaging window 220. In some further embodiments, the emitter of distance detector 110 may be isolated from the sensor such that distance detector 110 does not determine false or erroneous distances. The isolation may be such that the emission by the emitter may not be substantially detected by the sensor when the emission is reflected off rear-view assembly 200 and/or imaging window 220. This isolation may be achieved by a partition disposed between the emitter and the sensor. Such isolation may prevent the emission from being prematurely detected by the sensor. In FIGS. 2b-d, the collection of distance detector 110, IR illumination device 120, and/or imager 130 is represented as system sub-group 230. FIGS. 2b-2d illustrate cross sectional schematics of embodiments of rearview assembly 200.

As represented in FIGS. 2b-2d, rearview assembly 200 may further comprise a primary substrate 240 and a reflective layer 251 or a display 252. Reflective layer 251 or display 252 may be optically aligned with rear-view portion 210.

Primary substrate 240 may comprise a first surface 241 and a second surface 242. First surface 241 may be a surface facing subject 160. Second surface 242 may be a surface opposite first surface 241. First surface 241 may comprise all or part of front surface 201. In some embodiments, primary substrate 240 may comprise an electro-optic element. The electro-optic element may be electrochromic. Accordingly, the electro-optic element may be operable to vary between different states of light transmissiveness. In some embodiments, as shown in FIGS. 2b-2c, primary substrate 240 may extend into both rear-view portion 210 and imaging window 220. In other embodiments, as shown in FIG. 2d, primary substrate 240 may be excluded from imaging window 220. In embodiments where primary substrate 240 extends into both the rear-view portion 210 and the imaging window 220, primary substrate 240 may comprise any material that substantially transmits light in both the visible and IR regions of the electromagnetic spectrum. For example, primary substrate 240 may be comprised of any suitable material, many of which are well known in the art, such as, magnesium fluoride, N-BK7, zinc selenide, or zinc sulfide. In embodiments where primary substrate 240 may be excluded from imaging window 220, primary substrate 240 may comprise any material that substantially transmits light in the visible region of the electromagnetic spectrum. Accordingly, primary substrate 240 may be comprised of any suitable material, many of which are well known in the art, such as, borosilicate glass, soda lime glass, float glass, natural and synthetic polymeric resins, plastics, and/or composites.

Reflective layer 251 may be disposed on or within primary substrate 240. Accordingly, reflective layer 251 may be disposed on first surface 241 or second surface 242. In some embodiments, reflective layer 251 may be disposed substantially across the entirety of the surface. Reflective layer 251 may comprise any highly reflective material suitable for a mirror, many of which are well known in the art. In some embodiments, reflective layer 251 is disposed such that it does not extend into imaging window 220. Accordingly, reflective layer 251 may be disposed such that primary substrate 240 is not completely occluded, thereby defining imaging window 220. In other words, reflective layer 251 may be excluded from imaging window 220. In some embodiments, the complete occlusion avoidance may be achieved by disposing reflective layer 251 over only part of a surface of primary substrate 240.

Display 252 may be disposed rearward primary substrate 240. Accordingly, display 252 may be on rear surface 240. Display 252 may be operable to display a digital image from a rear-view camera. Accordingly, display 252 may be LCD, LED, OLED, plasma, DLP, or other technology. The digital image may be displayed through first surface 201 at rearview portion 210.

In some embodiments, as represented in FIGS. 2c-d, rear-view assembly 200 may further comprise a cloaking substrate 260. Cloaking substrate 260 may be disposed such that it substantially corresponds with imaging window 220. Further, cloaking substrate 260 may be comprised of any material that is substantially transmissive in the IR region and is substantially opaque in the visible region of the electromagnetic spectrum. Accordingly, cloaking substrate 260 may be comprised of any suitable material, many of which are well known in the art, such as, germanium or silicon. Therefore, imaging window 220 may be substantially opaque in the IR region. In some embodiments, as shown in FIG. 2c, cloaking substrate 260 may be disposed on primary substrate 240. For example, cloaking substrate 260 may be disposed on rear surface 242. In such an embodiment, primary substrate 240 may extend into imaging window 220. In other embodiments, as shown in FIG. 2d, cloaking substrate 260 may be disposed adjacent primary substrate 240 such that they are substantially aligned edge to edge. In such an embodiment, primary substrate 240 may be substantially excluded from imaging window 220.

In operation, distance detector 110 may measure the first distance 150 between itself and subject 160. The distance measurement may then be communicated to controller 140. Controller 140 may in turn determine an IR illumination intensity based, at least in part, on the measured first distance 150. The determined IR illumination may be equal to or less than the maximum safe IR illumination intensity for a subject the first and/or second distance 150, 170 from IR illumination device 120. The controller accordingly may configure IR illumination device 120 to illuminate subject 160 at the determined IR illumination intensity. Further, substantially synchronous with the IR illumination, imager 130 may image subject 160.

In some embodiments, based, at least in part, on the images produced by imager 130, controller 140 may execute the subject analysis algorithm and determine the subject's 160 attentiveness and/or extract at least one biometric signature. Additionally, controller 140 may match the biometric signature to a subject profile and unlock a door and/or implement preferences onto one or more pieces of equipment 180 based, at least in part, on the subject profile. Moreover, the implemented preferences may be limited based on the subject's 160 location.

Some embodiments of the variable IR illumination imaging system 100 may have the advantage of enabling heightened and/or maximum illumination of subject 160 based on the subject's 160 distance, and therefore enables better imaging, while minimizing or substantially reducing the risks associated with IR exposure. Additionally, when distance detector 110, IR illumination device 120, and/or imager 130 are disposed behind and in optical communication with imaging window 220, the present disclosure may have the further advantage of concealing one or more elements of variable IR illumination imaging system 100 and providing a clean, sleek aesthetic appearance.

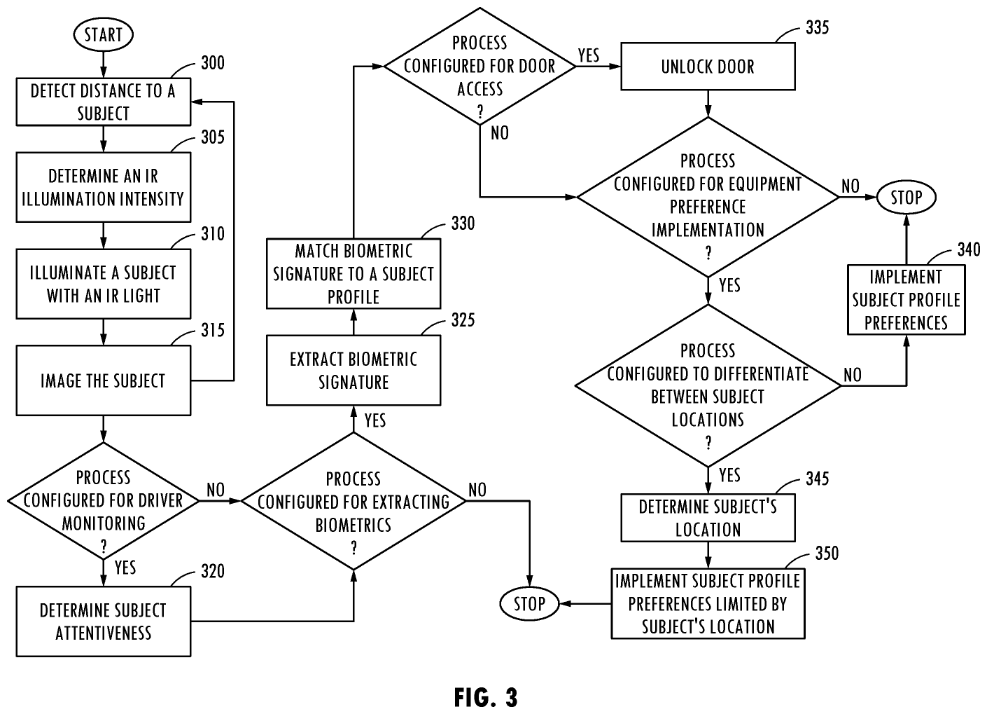

FIG. 3 is a process flow chart for variable IR illumination and imaging. The process comprises the steps of detecting a distance to a subject 300, determining an IR illumination intensity 305, illuminating the subject with IR light 310, and imaging the subject 315. In some embodiments, the process may be cyclical wherein after imaging the subject in step 315, the process may return to step 300.

In step 300, a first distance to a subject is detected. The distance may be detected by a distance detector, such as, a radar detector, a photoelectric sensor, a lidar detector, or an ultrasonic sensor. Accordingly, the first distance may be the distance between the distance detector and the subject. Further, the distance detector may be disposed such that the distance between itself and the subject is approximately equal to or similar to a distance between the subject an IR illumination device.

In step 305, an IR Illumination intensity may be determined. The IR illumination may be determined by a controller and based, at least in part, on the detected first distance between the distance detector and the subject. The determined IR illumination intensity is less than or equal to a maximum safe IR illumination intensity for a subject the first and/or second distance from the IR illumination device.

In step 310, the subject is illuminated with IR light. The subject may be illuminated by an IR illumination device. Further, the subject may be illuminated with IR light at the determined IR illumination intensity. The IR illumination device may be any device operable to emit light in the IR region of the electromagnetic spectrum. For example, IR illumination device may be a LED, halogen, quartz, incandescent, or CFL light bulb. In some embodiments, the illumination is substantially limited to the non-visible region of the electromagnetic spectrum. Additionally, the distance between the IR illumination device and the subject may be approximately equal to or similar to the detected distance.

In step 315, the subject may be imaged in the IR region. The subject may be imaged by an imager. The imager may be any device operable to capture light in the IR spectrum and produce a digital image. Accordingly, the imager may be a camera. For example, the imager may comprise Semi-Conductor Charge-Coupled Device (CCD) or pixel sensor of Complementary Metal-Oxide-Semi-Conductor (CMOS) technologies. Additionally, the imager may be disposed such that the IR light reflected off subject from the IR illumination device is substantially directed to the imager.

In some embodiments, the process may be configured for driver monitoring. Accordingly, the process may further comprise the step of determining the subject's attentiveness 320. In step 320, the controller may execute a subject analysis algorithm operable to determine the subject's attentiveness based, at least in part, on the image or images captured of the subject in step 315. The subject's attentiveness may be determined in part by the subject's head position, head movement, body movement, eye closure, vehicle control input, vehicle position on the road, and/or vehicle position relative to other vehicles. In some further embodiments, the subject analysis algorithm may also base, at least in part, its attentiveness determination on the detected first distance by the distance detector. This may be particularly beneficial in embodiments where the first distance between the distance detector and the subject corresponds to a distance between the distance detector and the subject's head.

Additionally or alternatively to the determination of the subject's attentiveness 320, the process may be configured for extracting biometrics. Accordingly, the process may further comprise the step of extracting a biometric signature 325. In step 325, the controller may execute a subject analysis algorithm operable to extract a biometric signature based, at least in part, on the image or images captured of the subject in step 315. The biometric signature, for example, may comprise one or more facial feature for facial recognition or iris structure for an iris recognition. After extracting the biometric signature 325, the process may additionally comprise the step of matching the biometric signature to a subject profile 330.

In step 330, the extracted biometric signature may be matched to a subject profile. One or more subject profiles may be stored in a memory of the controller, each subject profile being associated with a biometric signature. Based, at least in part, on the extracted biometric signature, the controller may retrieve the corresponding subject profile. The subject profile may comprise one or more preference for one or more pieces of equipment. The equipment may be, for example, a vehicle, a vehicle computer, a mirror, a window, a radio, a dashboard, a steering wheel, a foot pedal system, or a lighting system. The preference may be, for example, a seat position, window tint level, radio station, radio volume, maximum vehicle speed, driving mode, dashboard illumination, mirror position, rearview display vs mirror preference, steering wheel position, pedal position, or lighting level or color.

In some embodiments, the process may further be configured for door access. Accordingly, the process may proceed to step 335 wherein a door is unlocked. The door may be unlocked based on the matching of the biometric signature to a subject profile with door access authorization. The door may be a vehicle door.

Additionally or alternatively to being configured for door access, in some embodiments, the process may be configured to implement one or more equipment preferences based, at least in part, on the subject profile. How the preferences are implemented, may depend on whether the process is configured to differentiate between subject locations. The location may be in a vehicle, such as a driver's seat or a passenger's seat.

In some embodiments where the process is not configured to differentiate between subject locations, the process may proceed to step 340. In step 340, the subject profile preferences may be implemented, and one or more controllers may reconfigure one or more pieces of equipment in accordance with the user profile preferences. In some embodiments, the controller(s) may implement all of the user preferences for which the equipment is present.

In some embodiments where the process is configured to differentiate between subject locations, the process may proceed to step 345. In step 345 the subject's location may be determined. The determination may be made by the controller. Further, the location determination may be made by analyzing an image, by receiving an articulation of the imager, or by receiving images from a particular imager. Upon determining the subject's location, the process may proceed to step 350.

In step 350, the subject profile preferences may be implemented, but the implementations may be limited according to the subject's location such that one or more preference is not implemented. For example, a subject located in a passenger seat may have the preferences limited such that one or more of window tint level, radio station, radio volume, maximum vehicle speed, driving mode, dashboard illumination, mirror position, rearview display vs mirror selection, steering wheel position, pedal position, or lighting level or color preference are not implemented. The un-implemented preferences may have implementation limited to other locations, such as a driver's seat.

Some embodiments of the present disclosure may have the advantage of enabling heightened and/or maximum illumination of a subject, and thereby better imaging, while minimizing or substantially reducing the risks associated with IR exposure.

In this document, relational terms, such as “first,” “second,” and the like, are used solely to distinguish one entity or action from another entity or action, without necessarily requiring or implying any actual such relationship or order between such entities or actions.

As used herein, the term “and/or,” when used in a list of two or more items, means that any one of the listed items can be employed by itself, or any combination of the two or more of the listed items can be employed. For example, if a composition is described as containing components A, B, and/or C, the composition can contain A alone; B alone; C alone; A and B in combination; A and C in combination; B and C in combination; or A, B, and C in combination.

The term “substantially,” and variations thereof, will be understood by persons of ordinary skill in the art as describing a feature that is equal or approximately equal to a value or description. For example, a “substantially planar” surface is intended to denote a surface that is planar or approximately planar. Moreover, “substantially” is intended to denote that two values are equal or approximately equal. If there are uses of the term which are not clear to persons of ordinary skill in the art, given the context in which it is used, “substantially” may denote values within about 10% of each other, such as within about 5% of each other, or within about 2% of each other.

The term “opaque” is applied in the relative sense. “Opaque” refers to an optical element or material that is not appreciably transparent or translucent at wavelengths in question and thus generally does not allow light at such wavelengths to pass therethrough. The wavelengths in question will vary based on the context. However, in the event the wavelengths in question is not readily apparent, the wavelengths in question shall generally refer to visible light.

The term “transparent” is applied in the relative sense. “Transparent” refers to an optical element or material that is substantially transmissive of at wavelengths in question and thus generally allows light at such wavelengths to pass therethrough. The wavelengths in question will vary based on the context. However, in the event the wavelengths in question is not readily apparent, the wavelengths in question shall generally refer to visible light.

The terms “including,” “comprises,” “comprising,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. An element preceded by “comprises a . . . ” does not, without more constraints, preclude the existence of additional identical elements in the process, method, article, or apparatus that comprises the elements.

It is to be understood that although several embodiments are described in the present disclosure, numerous variations, alterations, transformations, and modifications may be understood by one skilled in the art, and the present disclosure is intended to encompass these variations, alterations, transformations, and modifications as within the scope of the appended claims, unless their language expressly states otherwise.

What is claimed is:

1. A system comprising:
a distance detector operable to detect a first distance to a subject;
a controller operable to determine an illumination intensity based, at least in part, on the first distance, the determined illumination intensity equal to or less than a maximum safe infra-red illumination intensity;
an infra-red illumination device operable to illuminate a subject with infra-red light at the determined illumination intensity, the infra-red illumination device located at a second distance from the subject, the second distance approximately equal to the first distance; and
an imager operable to capture one or more infra-red images of the illuminated subject.

2. The system of claim 1, wherein:
the controller is further operable to determine the subject's attentiveness based, at least in part, on the one or more images; and
the subject is a vehicle driver.

3. The system of claim 2, wherein the controller is further operable to determine the subject's attentiveness based, at least in part, on the first distance.

4. The system of claim 1, wherein the controller is operable:
to extract at least one biometric signature of the subject from the one or more images, and match the biometric signature to a subject profile.

5. The system of claim 4, wherein the subject profile comprises one or more subject preferences, wherein a subject preference is one of seat position, window tint, radio station, radio volume, maximum vehicle speed, driving mode, dash illumination, mirror position, mirror vs display selection, steering wheel position, pedal position, or lighting preference.

6. The system of claim 5, wherein the controller is further operable to implement the one or more subject preferences.

7. The system of claim 6, wherein the controller determines the subject's location and limits the implementation of the one or more subject preferences based, at least in part, on the subject's location, such that one or more of the subject preferences is not implemented.

8. The system of claim 1, wherein the distance detector further comprises an emitter operable to emit an emission and an emission sensor, the emission sensor isolated from the emitter such that the sensor may not substantially detect the emission except when the emission is reflected off an object disposed in an anticipated subject occupation area.

9. The system of claim 3, wherein the controller is further operable to unlock a vehicle door based, at least in part, on the biometric signature.

10. The system of claim 1, further comprising a rear-view assembly having:
a front surface;
a rear-view portion operable to provide a subject with a view in a rearward direction of a vehicle; and
an imaging window portion substantially transparent in the infra-red region of the electromagnetic spectrum;
wherein at least one of the distance detector, the infra-red illumination device, and the imager are:
disposed behind the front surface, and
optically aligned with the imaging window portion.

11. The system of claim 10, wherein the distance detector, the infra-red illumination device, and the imager are each disposed behind the front surface.

12. The system of claim 10, wherein the imaging window portion is substantially opaque in the visible region of the electromagnetic spectrum.

13. The system of claim 1, wherein the distance detector comprises an emitter operable to emit an emission and an emission sensor, the emission sensor isolated from the emitter by a partition.

14. The system of claim 1, wherein the determined infra-red illumination intensity is zero when the first distance is below a threshold.

15. A method comprising:
detecting a subject's distance to an infra-red illumination device;
determining an infra-red illumination intensity based, at least in part, on the detected distance, the determined infra-red illumination intensity equal to or less than a maximum safe infra-red illumination intensity;
illuminating the subject with infra-red light by an illumination device at the determined infra-red illumination intensity; and
imaging the subject in the infra-red region with an imager to capture one or more images.

16. The method of claim 15, further comprising determining the subject's attentiveness based, at least in part, on the one or more images.

17. The method of claim 16, wherein the determination of the subject's attentiveness is further based, at least in part, on the detected distance.

18. The method of claim 15, further comprising:
extracting at least one biometric signature from the one or more images; and
matching the biometric signature to a subject profile.

19. The method of claim 18, further comprising implementing one or more preferences from the subject profile onto one or more pieces of equipment.

20. The method of claim 19, further comprising:
determining the subject's location, and
limiting the implemented preferences based, at least in part, on the subject's location such that one or more preference is not implemented.
